(19) United States
(12) Patent Application Publication
(10) Pub. No.: US 2024/0212018 A1
(43) Pub. Date: Jun. 27, 2024

(54) SERVICE PRODUCT PROVISIONING

(71) Applicant: DISH Wireless L.L.C., Littleton, CO (US)

(72) Inventors: Scott Caldarella, Parker, CO (US); Angela Nelson, Aurora, CO (US); Arjun Kalura, Highlands Ranch, CO (US)

(21) Appl. No.: 18/349,817

(22) Filed: Jul. 10, 2023

Related U.S. Application Data
(60) Provisional application No. 63/476,549, filed on Dec. 21, 2022.

(51) Int. Cl. G06Q 30/0601

(52) U.S. Cl. CPC G06Q 30/0631

(57) ABSTRACT

A method for provisioning a service product to a user is provided. The method includes: receiving information regarding a user on a front-end channel; sending the information to an analytic service to obtain intention information of the user; receiving the intention information from the analytic service; determining one or more actions based on the intention information, the one or more actions including a first action indicating provisioning the service product according to the information regarding the user; and transmitting an instruction to an orchestration server according to the first action to cause the orchestration server to provision the service product.

### CROSS REFERENCE TO RELATED APPLICATIONS

This application claims priority to U.S. Provisional Patent Application No. 63/476,549, filed on Dec. 21, 2022, the disclosure of which is incorporated by reference in its entirety for all purposes.

### BACKGROUND

In many markets of the modern commerce system, businesses must look for every opportunity to acquire new customers and provide high quality products and services while minimizing costs wherever possible in order to remain competitive. As part of their business objectives, many businesses aim to provide customers with a communication platform for asking questions or providing feedback about products or services. The cost and infrastructure for employing and training enough employees and agents to service every customer with a question may be very expensive or even cost prohibitive. Further, the customer may experience inconvenient communication and sometimes frictional interaction with agents representing the business. Thus, there is a need to provide businesses with automated tools to facilitate communication with customers, improve customer onboarding experience, and provide customers with the information and service product they desire, while also facilitating low cost, high efficiency, and high profitability for the businesses.

### SUMMARY

In some embodiments, a method for provisioning a service product to a user is provided. The method includes: receiving information regarding a user on a front-end channel; sending the information to an analytic service to obtain intention information of the user; receiving the intention information from the analytic service; determining one or more actions based on the intention information, the one or more actions including a first action indicating provisioning the service product according to the information regarding the user; and transmitting an instruction to an orchestration server according to the first action to cause the orchestration server to provision the service product.

In some embodiments, a customer onboarding system is provided. The customer onboarding system includes a front-end channel, an analytic server, and an orchestration server. The front-end channel is configured to communicate with a user; receive information regarding the user provide by the user; and send the information regarding the user to the analytic server. The analytic server is configured receive and analyze the information regarding the user; generate intention information corresponding to the information regarding the user; determine one or more actions based on the intention information, wherein the one or more actions include a first action indicating provisioning the service product according to the information regarding the user; and transmit an instruction to an orchestration server according to the first action. The orchestration server is configured to receive the instruction and provision the service product to the user according to the instruction.

In some embodiments, the present disclosure provides a non-transitory machine-readable storage medium encoded with instructions, the instructions executable to cause a processor of a customer onboarding system to perform one or more operations of a method, wherein the method includes: receiving information regarding a user on a front-end channel; sending the information to an analytic service to obtain intention information of the user; receiving the intention information from the analytic service; determining one or more actions based on the intention information, the one or more actions including a first action indicating provisioning the service product according to the information regarding the user; and transmitting an instruction to an orchestration server according to the first action to cause the orchestration server to provision the service product.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a schematic diagram illustrating an example of a system according to various embodiments.

FIG. 2 is a schematic diagram illustrating an example of a web interface according to various embodiments.

FIG. 3 is a flowchart diagram illustrating an example of a method according to various embodiments.

FIG. 4 is a flowchart diagram illustrating an example of workflow according to various embodiments.

FIG. 5 is a flowchart diagram illustrating another example of workflow according to various embodiments.

FIG. 6 is a flowchart diagram illustrating yet another example of workflow according to various embodiments.

FIG. 7 is a flowchart diagram illustrating a further example of workflow according to various embodiments.

FIG. 8 is a schematic diagram illustrating an embodiment of a computer system according to various embodiments.

### DETAILED DESCRIPTION

In various embodiments, a method is provided to provision a service product to a customer. One insight provided by the present disclosure is that the method employs an automatic onboarding system that creates interactive and frictionless experience for the customers. The method utilizes intelligent workflows and enables the customers with interactive online experience. The method can also guide customers through onboarding, reduce the industry standard for onboarding turnaround time for the customers, decrease the onboarding process timeframe, minimize the resources used to onboard new customers, reduce the number of account managers supporting customer onboarding, and increase the volume of simultaneous customers.

Another insight provided by the present disclosure is to provide interfaces to users on front-end channels such as a website to assist the users towards learning more about service products and deciding which service product(s) to select. In some embodiments, the interfaces include a chat interface where a virtual assistant is provided to help the users on the front-end channels by finding out user intention and providing information about the service products based on the user intention.

Yet another insight provided by the present disclosure is to provide interfaces to the users on the front-end channels such as a website to enable the users to create service accounts and/or have one or more selected service products provisioned on an orchestration server. In some embodiments, the interfaces include a chat interface where natural language conversation is engaged with a given user for the given user to provide information for creating the service accounts and/or service provisioning.

Still another insight provided by the present disclosure is that the method can analyze and process the real-time information provided by the customer, accurately predict the customer's intention and interest, generate intention information of the customer, and transmit the intention information to the customer onboarding system to allow the customer onboarding system to make timely responses to the customer regarding the service product.

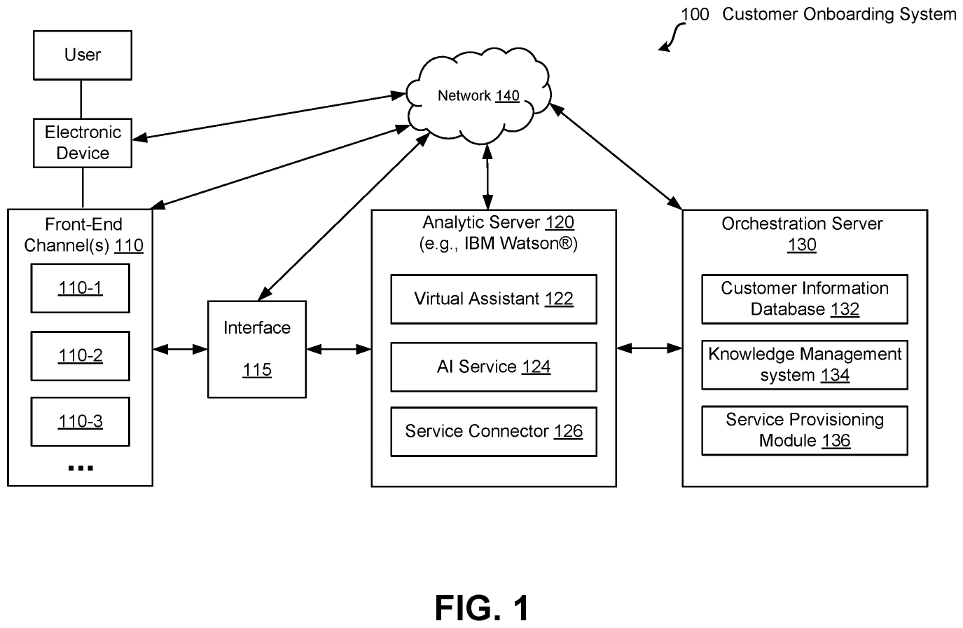

Now referring to FIG. 1, a system 100 and various components or subsystems thereof will be illustrated and described. FIG. 1 is a schematic diagram illustrating an example of system 100 according to various embodiments. In the illustrated example, the system 100 is a customer onboarding system configured to perform at least one of the following functions: communicate with a customer; provision a service product by a business; and providing information to the customer about one or more service products. In some embodiments, the customer onboarding system is configured to automatically communicate with the customer without additional assistance or interference from a human agent.

In some embodiments, the system 100 includes, among other components, one or more front-end channels 110, one or more interfaces 115, an analytic server 120, an orchestration server 130, and a communication network 140. The front-end channel 110 may be in communication with the interfaces 115. The front-end channel 110 may operate as a system for engaging and managing conversations between an automated chat robot and human users. In some embodiments, the front-end channel 110 may be maintained as in-house facility for a business or enterprise in performing the functions of sales and service relative to the products and services available through the business or enterprise. In some embodiments, the front-end channel 110 may be operated by a third-party service provider. In some embodiments, the front-end channel 110 may operate as a hybrid system in which some components of the front-end channel are hosted at a contact center premises and other components are hosted remotely (e.g., in a cloud-based environment).

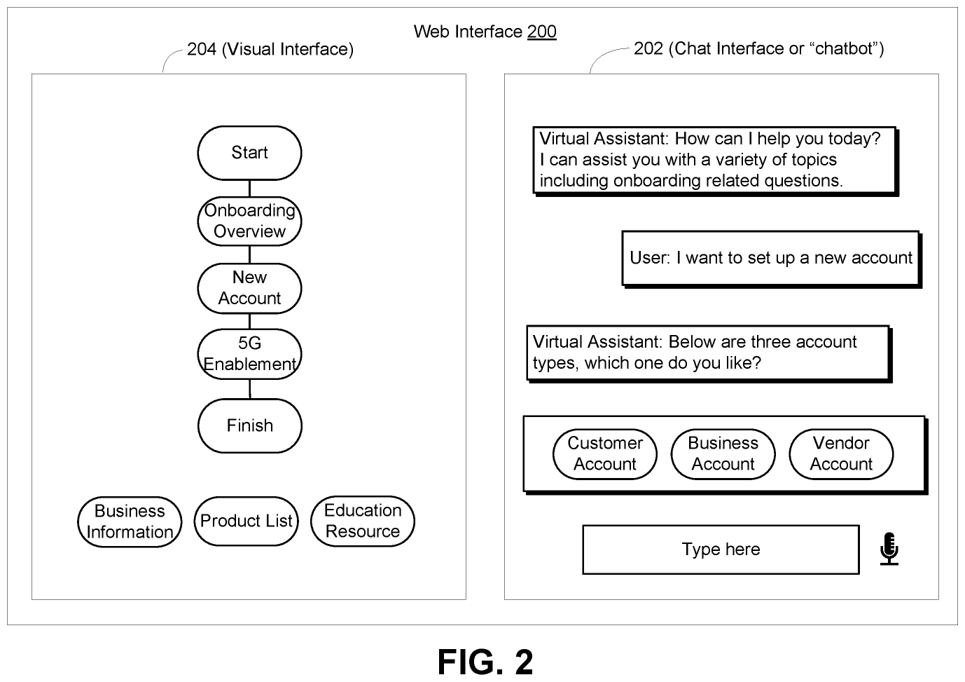

Customers, potential customers, or other end users (collectively referred to as customers or users) desiring to receive services from the front-end channel or the business operating the front-end channel may initiate an inbound communication to the front-end channel via their electronic devices. The customer may be an individual customer, a supplier customer, a seller, an APP/API developer, a business partner, or a potential customer interested in the business or service products provisioned by the business. The electronic device may be a communication device conventional in the art, such as, for example, a telephone, wireless phone, smartphone, personal computer, electronic tablet, or the like, that is configured to engage in text-based (e.g., chat) communications with other electronic devices. In some embodiments, users operating the electronic devices may communicate with the front-end channel 110 by way of a voice channel, and the communication may be converted into text either at the user or the front-end channel. The text may then be transmitted to a chatbot (e.g., the chatbot 202 shown in FIG. 2 and described in more detail below), and the response from the chatbot may be converted back into speech or delivered to the user's electronic device as text. Users operating the electronic devices may initiate, manage, and respond to telephone calls, emails, chats, text messaging, web-browsing sessions, and other multi-media transactions.

In some embodiments, inbound and outbound communications from and to the electronic devices may traverse the telephone, cellular, or the communication network 140 depending on the type of device that is being used. For example, the communications network 140 may include a private or public switched telephone network (PSTN), local area network (LAN), private wide area network (WAN), and/or public wide area network such as, for example, the Internet. The communications network 140 may also include a wireless carrier network including a code division multiple access (CDMA) network, global system for mobile communications (GSM) network, or any 3G or 4G or 5G network.

In some embodiments, the customer onboarding system 100 has a plurality of front-end channels 110 including a first front-end channel 110-1, a second front-end channel 110-2, a third front-end channel 110-3, . . . , and so on. The first front-end channel 110-1 may be a web server. The second front-end channel 110-2 may be an APP server. The third front-end channel 110-3 may be a communication portal. The communication portal may be a customer portal, a wholesale portal, an enterprise portal, a marketplace portal, a sales portal, etc. The communication portals may be provided and operated by a third-party service provider such as Salesforce®. The front-end channel 110 is configured to receive information regarding the user from the inbound communication and to transmit information regarding the service product from the outbound communication back to the user's electronic device.

In some embodiments, the customer onboarding system 100 includes multiple interfaces 115. The interfaces 115 are in communication with the front-end channel(s) 110. The interfaces 115 provide a communication platform for the user to communicate with the analytic server 120. In some embodiments, the interfaces 115 may include a Web user interface or Web app that allows the user to interact with content or software running on the customer onboarding system 100 through a Web browser. In some embodiments, the interfaces 115 include a graphic user interface (GUI) leveraging various applications to provide users with one or more access points to initiate a conversation with the analytic server 120 and other components of the customer onboarding system 100. In some embodiments, the multiple interfaces 115 include a chat interface (conversation user interface) where natural language conversation is engaged with a given user for the given user to provide information for creating the service accounts and/or service provisioning.

FIG. 2 illustrates an example web interface 200 according to various embodiments. The web interface 200 is an example of the interface 115 shown in FIG. 1. In the illustrated example, the web interface 200 includes a chat interface 202 and a visual interface 204. In some embodiments, the chat interface 202 is an automated text-based communication system. The chatbot could minimize or altogether eliminate the need for agents to provide real-time text-based communications through the front-end channel 110. The chatbot can utilize systems deploying any number of automation technologies, (e.g., natural language process, machine learning, and artificial intelligence, etc.) that attempt to mimic outbound text-based communications from the front-end channel.

The chat interface 202 is configured to provide a chat box for the user to have a conversation with a virtual agent (e.g., the virtual assistant 122 of FIG. 1). In this example, the chat box is activated when the web interface 200 is opened, as illustrated by a conversation item. Here, the virtual assistant initiates the conversation with “How can I help you today? I can assist you with a variety of topics including onboarding related questions.” The user submits a response by typing texts or recording a speech message “I want to set up a new account” as illustrated by a conversation item. Based on this information, the analytic server 120 may determine that the intention information of the user is to open a new account. The virtual assistant of the analytic server then provides the user with various types of accounts, e.g., customer account, business account, and vendor account, for the user to select. The conversation proceeds on the chat interface 202, and the virtual assistant of the analytic server continues to guide the user to create the new account and/or respond to the user's further questions or inquiries.

The visual interface 204 is configured to provide the user a platform to make extensive use of graphical objects (icons, diagrams, forms, etc.) that the user may directly manipulate on the screen through pointing devices (e.g., a mouse or her/his fingers) and get instantaneous feedback (e.g., real-time interactivity). The visual interface 204 may provide web contents for the user to browse on the web interface 200. The web content may include a roadmap of the customer onboarding process and each step thereof, business knowledge such as educational resources of a technical area the user is interested in, and detailed information about a particular product or service, and so on.

The analytic server 120 is operably connected to the interface 115 and is configured to receive, analyze, and process the information regarding the user from the inbound communication; generate intention information of the user; and determine one or more actions based on the intention information.

In some embodiments, the analytic server 120 includes a virtual assistant 122 (e.g., IBM Watson®), an artificial intelligence (AI) service 124, and a service connector 126. The virtual assistant 122 may be operably connected to the interface 115. The virtual assistant 122 is operably connected to the interfaces 115 and is configured to engage the user in a conversational environment and minimize the frictional experience the user may have during the communication on the front-end channel 110.

The AI service 124 is configured to analyze and process the information regarding the user and generate intention information of the user based on the information provided by the user. The AI service 124 may further include, among other components, a natural language interpretation engine, a content analysis engine, a search engine, a data mining engine, a knowledge database, and a reporting engine. In some embodiments, the AI service 124 is capable of retrieving relevant information from information sources such as encyclopedias, dictionaries, newswire articles, literary works, or other documents stored in the knowledge database as reference materials. Through analysis of the information regarding the user, the AI service 124 generates intention information of the user based on the information regarding the user. The intention information represents the intention of the user on any product information or service product the user desires to obtain from the communication. Non-limiting examples of the service product include educational resources of the business, new account creation, order of new product, API development, etc. As an example, if the front-end channel receives an instant speech message submitted by the customer, where the speech message contains information “I am looking for your 5G service,” the submitted speech message is transmitted to the AI service 124 on the interface 115. The AI service 124 then processes the speech message, e.g., by translating the speech message into texts and analyzing the texts to generate intention information of the user, where the intention information reflects the customer's interests in a “5G service product.” The intention information can be instantaneously transmitted back to the user's electronic device to confirm with the user. The intention information can also be transmitted to the orchestration server 130, where further operations may be performed.

In some embodiments, the AI service 124 is further configured to analyze and process business knowledge (identified and communicated by the orchestration server 130) identified by the orchestration server 130 in response to the intention information of the user; determine the relevance of the business knowledge to the intention information of the user; determine the one or more actions based on the intention information and the business knowledge; and generate an instruction for provisioning a service product corresponding to the information of the user.

The service connector 126 is configured to communicate with the orchestration server 130. In some embodiments, the service connector 126 receives the intention information generated by the AI service 124 and transmits the intention information to the orchestration server 130. In some embodiments, the service connector 126 receives business knowledge identified by the orchestration server 130 and transmits it back to the AI service 124.

The orchestration server 130 is operably connected to and in communication with the analytic server 120. In some embodiments, the orchestration server 130 includes a customer information database 132, a knowledge management system 134, and a service provisioning module 136. As an example, the orchestration server 130 is embodied as an API management system (e.g., apogee) operated by the business. The orchestration server 130 is configured to receive the information regarding the user received by the front-end channel 110 and the intention information of the user generated by the analytic server 120; identify business knowledge in response to the intention information of the user; transmit the identified business knowledge back to the analytic server 120; and provision the service product corresponding to the customer information.

The customer information database 132 is configured to store, categorize, and organize customer information, including the information regarding the user as well as the corresponding intention information of the user generated by the analytic server 120. The customer information database 132 may provide a reference to guide and facilitate communication between the business with a returning customer. Historical customer information stored in the customer information database 132 may also be used by the analytic server 120 to improve the predictability of the AI service during an ongoing communication event with an onboarding user or a future communication event with a returning user.

The knowledge management system 134 may include a business knowledge database (not shown) and an information processer (not shown). The business knowledge database includes business knowledge, such as information regarding the business and products or services thereof, educational resources, product specifications, service information, pricing information, and so on. The information processor is configured to perform at least one of the following functions: retrieving the customer information (e.g., the customer information of the user and the intention information of the user) from the customer information database 132; identifying the business knowledge in response to the customer information; retrieving the identified business knowledge from the business knowledge database and transmitting the identified business knowledge back to the AI service 124 through the service connector 126.

In some embodiments, the AI service 124 upon receipt of the identified business knowledge evaluates and determines the relevancy of the business knowledge to the intention information of the user. If the business knowledge is determined to be sufficiently relevant to the intention information (e.g., passing a pre-determined threshold value), the AI service 124 will proceed to determine one or more actions based on the business knowledge and the intention information of the user. If the relevancy of business knowledge to the intention information of the user is determined to be insufficient, the AI service will proceed to send a request to the orchestration server 130 for more relevant business knowledge from the knowledge management system 134. The process may continue until the business knowledge provide is determined to be sufficiently relevant by the AI service 124.

The service provisioning module 136 is configured to receive the instruction generated by the AI service 124; execute the one or more determined actions provided in the instruction; and provision the service product according to the instruction to the user. In some embodiments, the service product includes links to educational resources and knowledge articles, instructions for new account creation, instructions for placing a purchase order, instructions for setting up contracts, and instructions for product creation.

In some embodiments, the orchestration server 130 further includes a customer acquisition module (not shown). The customer acquisition module may provide an operations support system (OSS) platform and a business support system (BSS) platform configured for revenue management, catalog, order management, invoice management, microservices, number management, etc. In some embodiments, the customer acquisition module may cooperate with the service provisioning module to provision the service product, where the service product includes a customer purchase order for a particular product of the business. In some embodiments, the service product of the service provisioning module 136 is provisioned to the user through a third-party provider (e.g., Salesforce) as an intermediary.

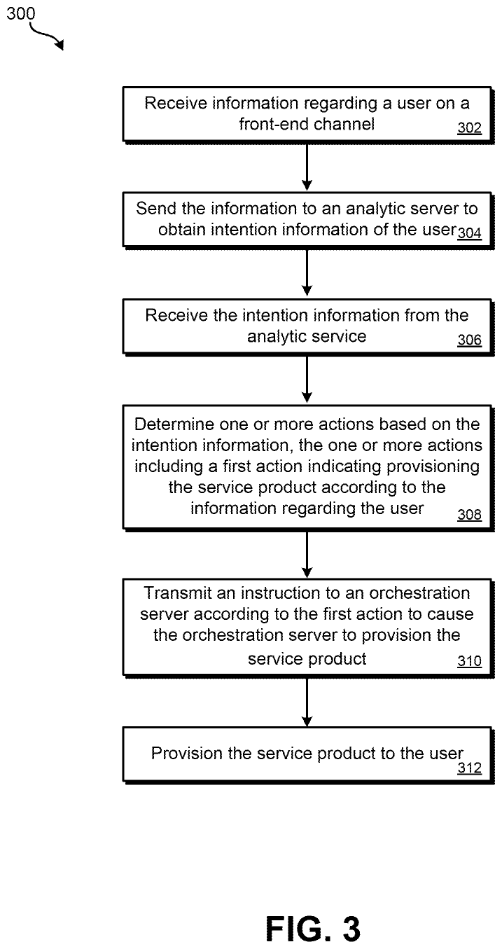

Now referring to FIGS. 3-7, examples of the methods and workflows according to various embodiments will be illustrated and described. FIG. 3 is a flowchart diagram illustrating an example of method 300. In the illustrated example, the method 300 includes operations 302, 304, 306, 308, and 310. At operation 302, information regarding a user provided by the user is received on a front-end channel of a customer onboarding system. In some embodiments, the received information is further transmitted to an interface in communication with the front-end channel. In some embodiments, a conversation is initiated on a chatbot (e.g., conversation user interface) of the interface upon receiving the information.

At operation 304, the information regarding the user received by the front-end channel is transmitted to an analytic server in communication with the interface. In some embodiments, the information regarding the user is received by a virtual assistant of the analytic server. The virtual assistant may automatically receive the real-time information submitted by the user on the interface. At operation 304, intention information of the user corresponding to the information provided by the user is obtained by the analytic server. In some embodiments, the customer information regarding the user is analyzed and processed by an AI service of the analytical server, which further generates the corresponding intention information of the user.

At operation 306, the intention information generated by the analytic server is transmitted to an orchestration server, through a service connector of the analytic server. In some embodiments, the intention information is transmitted to a customer information database of the orchestration server. In some embodiments, both the information regarding the user and the corresponding intention information of the user is transmitted to the customer information database, which further stores, categorizes, and organizes the received information.

At operation 308, one or more actions based on the intention information are determined by the AI service of the analytic server. In some embodiments, the intention information is retrieved from the customer information database by a knowledge management system of the orchestration server. The intention information is further analyzed and processed by an information processor of the knowledge management system to identify the business knowledge in response to the customer information. The identified business knowledge may be transmitted back to the AI service of the analytic server and further analyzed by the AI service. One or more actions are determined by the AI service based on the intention information and the relevant business knowledge from the knowledge management system. The one or more actions may include a first action indicating provisioning the service product according to the information regarding the user. In some embodiments, the one of more actions include indicating creating a new account for the user, guiding the user to place a purchase order, guiding the user to locate and learn business knowledge, guiding the user to set up a contract with the business, guiding the user to create or customize a product, and so on.

At operation 310, an instruction is transmitted to an orchestration server. In some embodiments, the instruction is generated by the AI service in response to the information regarding the user and the intention information of the user. The instruction may contain information or guidance to the customer regarding the determined one or more actions, including but not limited to links to educational resources and knowledge articles about the business or a product or service thereof, an instruction for creating a new account, an instruction for the user to place a purchase order, an instruction for the user to set up a contract, an instruction for the user to create or customize a product, and so on.

At operation 312, the service product is provisioned by the orchestration server to the user. In some embodiments, the service product is provisioned through a third-party provider and the instruction regarding the service product is communicated back to the user via the front-end channel.

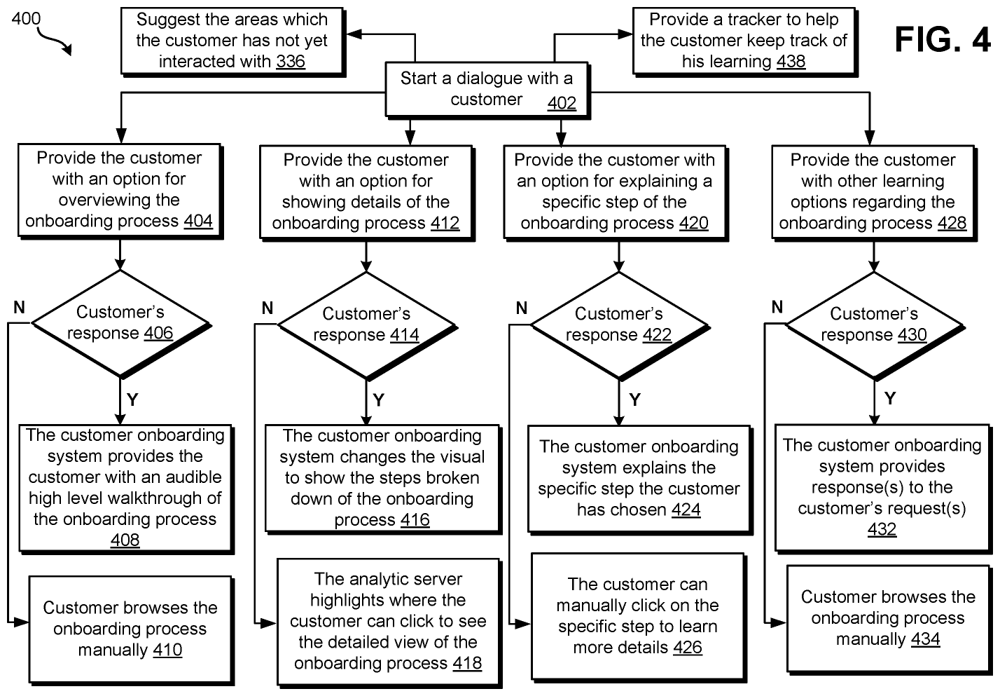

FIG. 4 is a flowchart diagram illustrating an example workflow 400 implementing the method 300. The workflow 400 may be used for provisioning customer onboarding service to a customer. On a customer onboarding system described here, the customer can request information about the onboarding process. The customer onboarding system provides a high-level overview for the customer of the steps that the onboarding process will entail. The customer also has the option(s) of selecting a specific step in the onboarding process to learn more.

In the illustrated example of FIG. 4, the workflow 400 starts at operation 402, where a conversational dialogue is initiated with a customer on a web interface. The dialogue may be carried out in a chatbot provided by a chatbot of the web interface that communicably connects the user's electronic device and a virtual assistant of an analytic server. At operation 404, the customer onboarding system provides the customer with an option for overviewing the onboarding process. At operation 406, the customer onboarding system receives a response from the customer regarding the option. If the customer responds with “yes,” the workflow proceeds to operation 408, where the customer onboarding system provides the customer with an audible high-level walkthrough of the onboarding process. If the customer responds with “no,” the workflow proceeds to operation 410, where the customer onboarding system instructs the customer to browse the onboarding process manually and indicates to the customer that no further assistance is provided unless requested.

Similarly, at operation 412, the customer onboarding system provides the customer with an option for showing details of the onboarding process. At operation 414, the customer onboarding system receives a response from the customer regarding the option. If the customer responds with “yes,” the workflow proceeds to operation 416, where the customer onboarding system changes the visual to show the steps of the onboarding process. If the customer responds with “no,” the workflow proceeds to operation 418, where the customer onboarding system highlights where the customer can click to see the detailed view of the onboarding process and indicates to the customer that no further assistance is provided unless requested.

Similarly, at operation 420, the customer onboarding system provides the customer with an option for explaining a specific step of the onboarding process. At operation 422, the customer onboarding system receives a response from the customer regarding the option. If the customer responds with “yes,” the workflow proceeds to operation 424, where the customer onboarding system explains the specific step(s) the customer has selected. If the customer responds with “no,” the workflow proceeds to operation 426, where the customer onboarding system instructs the customer to manually click on the specific step to learn more details and indicates to the customer that no further assistance is provided unless requested.

Similarly, at operation 428, the customer onboarding system provides the customer with other learning options regarding the onboarding process. At operation 430, the customer onboarding system receives a response from the customer regarding the option. If the customer responds with “yes,” the workflow proceeds to operation 432, where the customer onboarding system response(s) to the customer's request(s) regarding the learning options. If the customer responds with “no,” the workflow proceeds to operation 434, where the customer onboarding system instructs the customer to freely browse the onboarding process manually and indicates to the customer that no further assistance is provided unless requested.

At operation 436, the customer onboarding system suggestions the areas of the onboarding process, which the customer has not yet interacted with. At operation 438, the customer onboarding system provides a tracker to help the customer keep track of his learning.

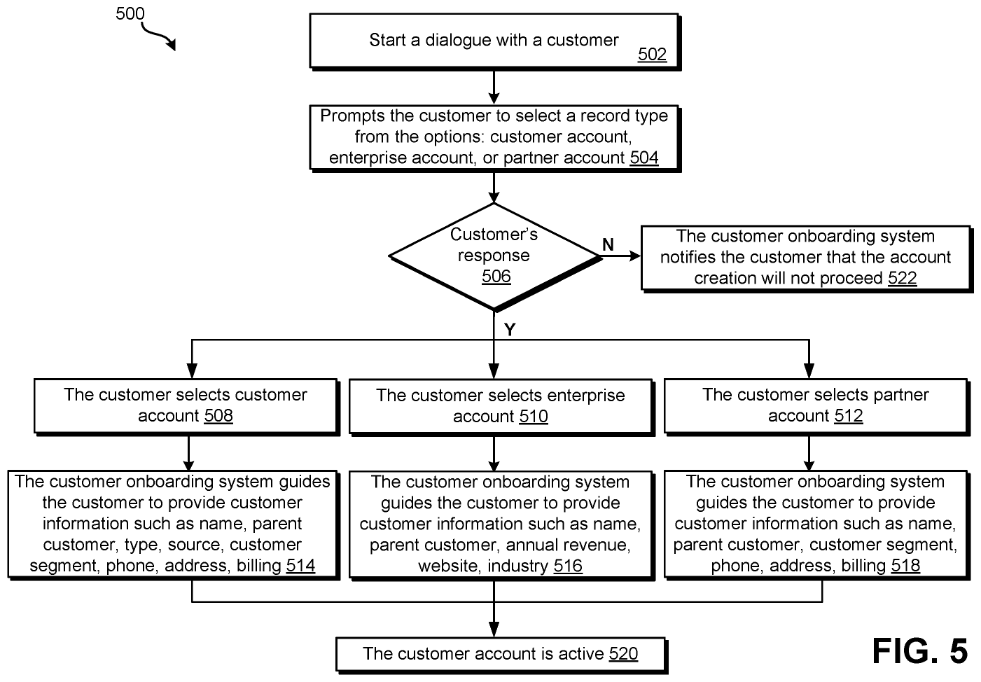

FIG. 5 is a flowchart diagram illustrating an example workflow 500 implementing the method 300. The workflow 500 may be used for provisioning an account creation service to a customer. On a customer onboarding system described here, a customer can be instructed by the customer onboarding system to fill out the required fields across multiple pages to create a customer account.

In the illustrated example of FIG. 5, the workflow 500 starts at operation 502, where a dialogue is initiated between a customer and a virtual assistant on an interface of a customer onboarding system described herein. At operation 504, the customer onboarding system prompts the customer to select a record type from the options: customer account, enterprise account, or partner account in a chatbot of the customer onboarding system. At operation 506, the customer onboarding system receives a response from the customer regarding the selection. If the customer responds with “yes,” the workflow 500 proceeds to operation 508, 510, or 512, depending on the customer's selection. If the customer responds with “no,” the customer onboarding system notifies the customer that the account creation will not proceed.

If the customer selects the customer account (e.g., individual or personal account) at operation 508, the workflow 500 proceeds to operation 514, wherein the customer onboarding system provisions an instruction for creating a customer account to guide the customer to provide customer information such as name, parent customer, type, source, customer segment, phone, address, billing. The customer can submit the required customer information to the customer onboarding system through the front-end channel. Upon receiving the required customer information, the customer onboarding system creates a customer account for the customer.

Similarly, if the customer selects the enterprise account (e.g., business account) at operation 510, the workflow 500 proceeds to operation 516, wherein the customer onboarding system guides the customer to provide enterprise information such as name, parent customer, annual revenue, website, industry. The customer can submit the required enterprise information to the customer onboarding system through the front-end channel. Upon receiving the required customer information, the customer onboarding system creates a customer account for the customer.

Similarly, if the customer selects the partner account (e.g., account to establish a business partnership) at operation 512, the workflow 500 proceeds to operation 518, wherein the customer onboarding system guides the customer to provide customer information such as name, parent customer, customer segment, phone, address, billing. The customer can submit the required enterprise information to the customer onboarding system through the front-end channel. Upon receiving the required customer information, the customer onboarding system creates a customer account for the customer. At operation 520, the customer onboarding system activates the customer account and provisions the customer account to the customer.

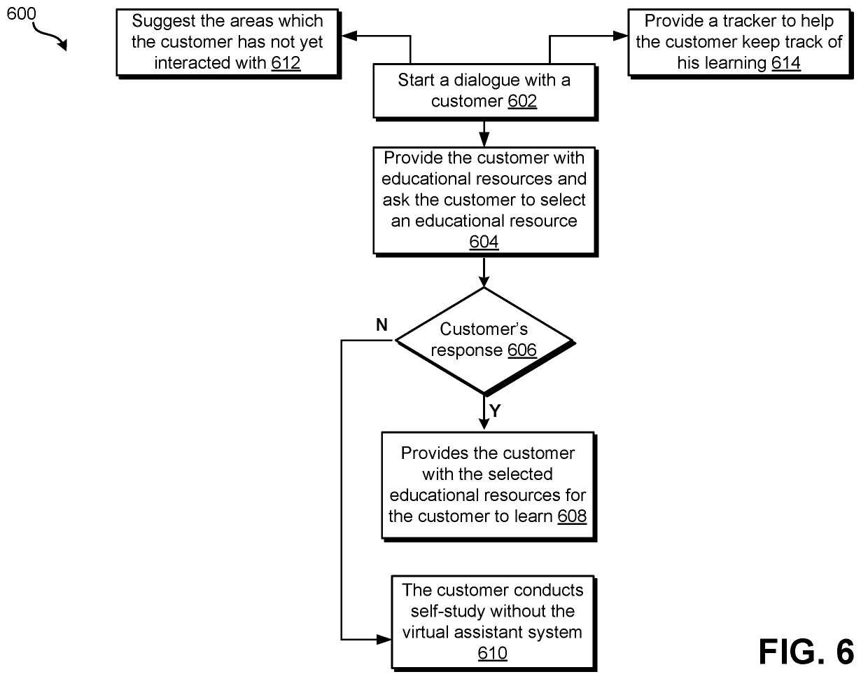

FIG. 6 is a flowchart diagram illustrating an example workflow 600 implementing the method 300. The workflow 600 may be used for provisioning education resources of the business to a customer. A customer onboarding system described here may walk the customer through the education resources or other knowledge information regarding the business.

In the illustrated example of FIG. 6, the workflow starts at operation 602, where a dialogue is initiated with a customer on a customer onboarding system. At operation 604, the customer onboarding system indicates to the customer that educational resources regarding the business are available upon request and ask the customer to select an educational resource. At operation 606, the customer onboarding system receives a response from the customer. If the customer responds with “yes,” the workflow proceeds to operation 608, where the customer onboarding system provides the customer with the selected educational resources for the customer to learn. If the customer responds with “no,” the workflow proceeds to operation 610, where the customer onboarding system instructs the customer to self-learn and indicates to the customer that no further assistance is provided unless requested. At operation 612, the customer onboarding system suggestions the areas of the onboarding process, which the customer has not yet interacted with. At operation 614, the customer onboarding system provides a tracker to help the customer keep track of his learning.

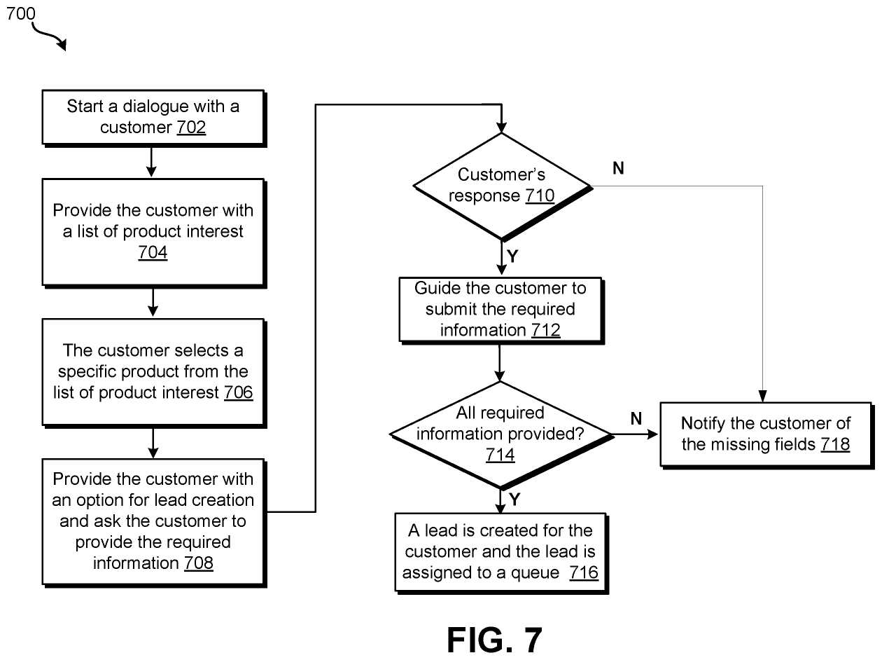

FIG. 7 is a flowchart diagram illustrating an example workflow 700 implementing the method 300. The workflow 700 may be used for provisioning a service product to a customer. A customer onboarding system described here may instruct the customer upon his or her request to fill out an interest form including the required fields to indicate interest in the service product. Once the customer completes the interest form, the customer onboarding system will create a lead for the customer.

In the illustrated example of FIG. 7, the workflow 700 starts at operation 702, wherein a dialogue between a customer is initiated on a customer onboarding system. At operation 704, the customer onboarding system provides the customer with a list of product interest include various products or service products provided by the business. At operation, the customer selects a specific product from the list of product interest. At operation 708, the customer onboarding system provides an option for lead creation and asks the customer to provide the required information to create the lead. At operation 710, the customer onboarding system receives a response from the customer. If the customer responds with “yes,” the workflow proceeds to operation 712, where the customer onboarding system guides the customer to submit the required information to the customer onboarding system. If the customer responds with “no,” the workflow proceeds to operation 718, where the customer onboarding system notifies the customer of the missing fields. At operation 714, the customer onboarding system determines if all required information has been provided by the customer. If yes, the workflow proceeds to operation 716, where the customer onboarding system creates a lead for the customer and assigns the lead to a queue based on the selected product interest. If no, the workflow proceeds to operation 718, where the customer onboarding system notifies the customer of the missing fields.

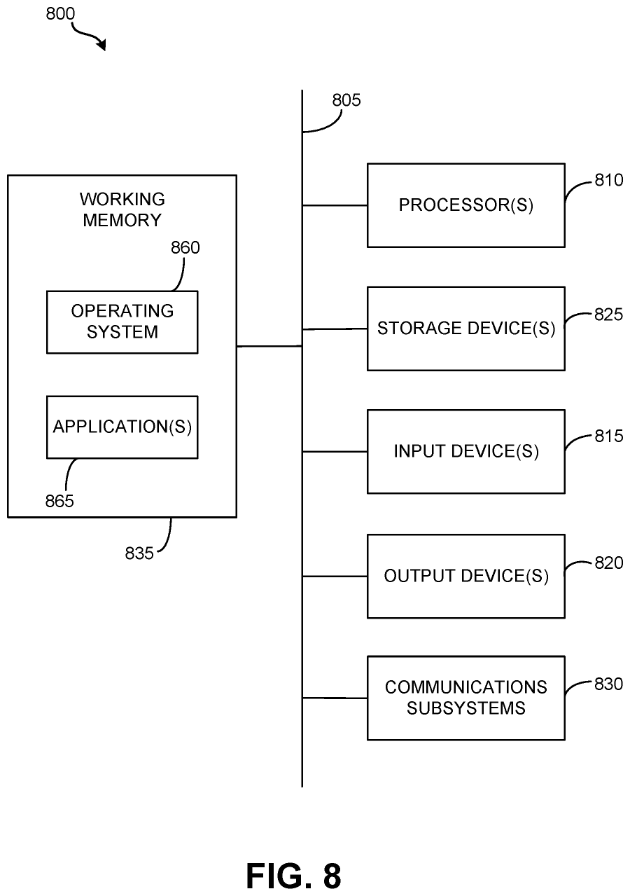

FIG. 8 is a schematic diagram illustrating an example of computer system 800. The computer system 800 is a simplified computer system that can be used implement various embodiments described and illustrated herein.

A computer system 800 as illustrated in FIG. 8 may be incorporated into devices such as a portable electronic device, mobile phone, or other device as described herein. FIG. 8 provides a schematic illustration of one embodiment of a computer system 800 that can perform some or all of the steps of the methods provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805, or may otherwise be in communication, as appropriate. The hardware elements may include one or more processors 810, including without limitation one or more general-purpose processors and/or one or more special-purpose processors such as digital signal processing chips, graphics acceleration processors, and/or the like; one or more input devices 815, which can include without limitation a mouse, a keyboard, a camera, and/or the like; and one or more output devices 820, which can include without limitation a display device, a printer, and/or the like.

The computer system 800 may further include and/or be in communication with one or more non-transitory storage devices 825, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device, and/or a chipset such as a Bluetooth™ device, an 602.11 device, a WiFi device, a WiMax device, cellular communication facilities, etc., and/or the like. The communications subsystem 830 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 830. In other embodiments, a portable electronic device, e.g., the first electronic device, may be incorporated into the computer system 800, e.g., an electronic device as an input device 815. In some embodiments, the computer system 800 will further comprise a working memory 835, which can include a RAM or ROM device, as described above.

The computer system 800 also can include software elements, shown as being currently located within the working memory 835, including an operating system 860, device drivers, executable libraries, and/or other code, such as one or more application programs 865, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 8, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 825 described above. In some cases, the storage medium might be incorporated within a computer system, such as computer system 800. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 800 and/or might take the form of source and/or installable code, which, upon compilation and/or installation on the computer system 800 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 800 to perform methods in accordance with various embodiments of the technology. According to a set of embodiments, some or all of the procedures of such methods are performed by the computer system 800 in response to processor 810 executing one or more sequences of one or more instructions, which might be incorporated into the operating system 860 and/or other code, such as an application program 865, contained in the working memory 835. Such instructions may be read into the working memory 835 from another computer-readable medium, such as one or more of the storage device(s) 825. Merely by way of example, execution of the sequences of instructions contained in the working memory 835 might cause the processor(s) 810 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 800, various computer-readable media might be involved in providing instructions/code to processor(s) 810 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 825. Volatile media include, without limitation, dynamic memory, such as the working memory 835.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 830 and/or components thereof generally will receive signals, and the bus 805 then might carry the signals and/or the data, instructions, etc. carried by the signals to the working memory 835, from which the processor(s) 810 retrieves and executes the instructions. The instructions received by the working memory 835 may optionally be stored on a non-transitory storage device 825 either before or after execution by the processor(s) 810.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method for provisioning a service product, the method being implemented by an electronic processor, and comprising:
receiving information regarding a user on a front-end channel;
sending the information regarding the user to an analytic server to obtain intention information of the user corresponding to the information regarding the user;
receiving the intention information from the analytic server;
determining one or more actions based on the intention information, the one or more actions including a first action that indicates provisioning the service product according to the information regarding the user; and
transmitting an instruction to an orchestration server according to the first action to cause the orchestration server to provision the service product.

2. The method according to claim 1, further comprising:
transmitting the information regarding the user to the analytic server; and
analyzing the information regarding the user by an artificial intelligence (AI) service of the analytic server.

3. The method according to claim 1, further comprising storing the information regarding the user and the corresponding intention information of the user in a customer information database of the orchestration server.

4. The method according to claim 2, further comprising identifying business knowledge in response to the intention information of the user, wherein the business knowledge is stored in a knowledge management system of the orchestration server.

5. The method according to claim 4, further comprising transmitting the identified business knowledge to the AI service.

6. The method according to claim 5, further comprising analyzing the identified business knowledge by the AI service to determine relevancy of the identified business knowledge to the intention information of the user.

7. The method according to claim 1, wherein the service product comprises at least one of: providing the user with an onboarding process; creating a customer account for the user; providing the user with education resources based on the intention information; and creating a lead based on a product interest selected by the user.

8. A computerized system for provisioning a service product, the computerized system comprising:
one or more electronic processors;
a machine-readable storage medium in electronic communication with the one or more electronic processors; and
instructions stored in the machine-readable storage medium and executable by the one or more electronic processors to cause the system to:
receive information regarding a user on a front-end channel;
send the information regarding the user to an analytic server to obtain intention information of the user corresponding to the information regarding the user;
receive the intention information from the analytic server;
determine one or more actions based on the intention information, the one or more actions including a first action that indicates provisioning the service product according to the information regarding the user; and
transmit an instruction to an orchestration server according to the first action to cause the orchestration server to provision the service product.

9. The computerized system according to claim 8, wherein the one or more processors are further instructed to cause the system to:
transmit the information regarding the user to the analytic server; and
analyze the information regarding the user by an artificial intelligence (AI) service of the analytic server.

10. The computerized system according to claim 8, wherein the one or more processors are further instructed to cause the system to store the information regarding the user and the corresponding intention information of the user in a customer information database of the orchestration server.

11. The computerized system according to claim 9, wherein the one or more processors are further instructed to cause the system to identify business knowledge in response to the intention information of the user, wherein the business knowledge is stored in a knowledge management system of the orchestration server.

12. The computerized system according to claim 11, wherein the one or more processors are further instructed to cause the system to:
transmit the identified business knowledge to an AI service; and
analyze the identified business knowledge by the AI service to determine relevancy of the identified business knowledge to the intention information of the user.

13. The computerized system according to claim 11, wherein the service product comprises at least one of: providing the user with an onboarding process; creating a customer account for the user; providing the user with education resources based on the intention information; and creating a lead based on a product interest selected by the user.

14. A non-transitory machine-readable storage medium encoded with instructions, the instructions executable to cause one or more electronic processors of a computerized product provisioning system to perform one or more operations of a method, the method comprising:
receiving information regarding a user on a front-end channel;
sending the information regarding the user to an analytic server to obtain intention information of the user corresponding to the information regarding the user;
receiving the intention information from the analytic server;
determining one or more actions based on the intention information, the one or more actions including a first action that indicates provisioning the service product according to the information regarding the user; and
transmitting an instruction to an orchestration server according to the first action to cause the orchestration server to provision the service product.

15. The non-transitory machine-readable storage medium according to claim 14, wherein the method further comprising:
transmitting the information regarding the user to the analytic server; and
analyzing the information regarding the user by an artificial intelligence (AI) service of the analytic server.

16. The non-transitory machine-readable storage medium according to claim 14, wherein the method further comprising storing the information regarding the user and the corresponding intention information of the user in a customer information database of the orchestration server.

17. The non-transitory machine-readable storage medium according to claim 15, wherein the method further comprising identifying business knowledge in response to the intention information of the user, wherein the business knowledge is stored in a knowledge management system of the orchestration server.

18. The non-transitory machine-readable storage medium according to claim 17, wherein the method further comprising transmitting the identified business knowledge to an AI service.

19. The non-transitory machine-readable storage medium according to claim 18, wherein the method further comprising analyzing the identified business knowledge by the AI service to determine relevancy of the identified business knowledge to the intention information of the user.

20. The non-transitory machine-readable storage medium according to claim 14, wherein the service product comprises at least one of: providing the user with an onboarding process; creating a customer account for the user; providing the user with education resources based on the intention information; and creating a lead based on a product interest selected by the user.
